(19) United States
(12) Patent Application Publication
(10) Pub. No.: US 2009/0074524 A1
(43) Pub. Date: Mar. 19, 2009

(54) Section member cutting or drilling machine tool

(76) Inventor: Alessandro Pirovano, Trevisago (IT)

Correspondence Address: Kirschstein, Israel, Schiffmiller & Pieroni, P.C., 425 FIFTH AVENUE, 5TH FLOOR, NEW YORK, NY, 10016-2223, US

(21) Appl. No.: 12/283,331

(22) Filed: Sep. 11, 2008

(30) Foreign Application Priority Data
Sep. 14, 2007 (IT) MI2007A-001768

(51) Int. Cl. B23B 47/00

(52) U.S. Cl. 408/76

(57) ABSTRACT

A section member cutting or drilling machine tool comprises a bearing or supporting surface for bearing a metal section member work piece thereon, a sliding guide extending parallel to the feeding, cutting and unloading surface of the machine tool and slidably supporting a contact plate in the form of a controllably energizable, respectively disenergizable magnet, the magnet plate being controllably driven by a controllable motor which, through a geared unit, drives a pinion-rack assembly arranged parallel to the sliding guide.

### BACKGROUND OF THE INVENTION

The present invention relates to a metal section member cutting or drilling machine tool.

As is known, large size metal section members, for example of a I-shape, must be cut to provide preset-length section member pieces, having a desired section member piece angle. The thus cut section member pieces are in particular used in structural steel works.

In prior section member sawing or drilling machines, for machining large size section members, the latter must be precisely fed to properly perform cutting and other machining operations at desired machining points.

While in the following disclosure reference will be made only to a section member sawing machine, it should be apparent that the inventive concept can be used either in a sawing or in a drilling machine for processing large size section members.

Prior section member sawing machines conventionally comprise a section member feeding device substantially comprising two controllable jaws, of a comparatively large size, coupled by a jaw feeding carriage, so as to allow the work piece to be precisely driven.

In particular, the prior work piece feeding system is so designed as to lock, by its pliers or jaws, the section members at the two sides thereof. Thus, such a prior device cannot be advantageously used for locking very small, complex or uneven cross-section section members, which cannot be easily and safely locked by the above mentioned locking jaws to be precisely fed.

Another drawback of the prior section member locking system is that it does not allow to properly lock small length section members, formed, for example, by section member butt-cutting operations, since said small length butt-cut work pieces frequently fall to the bottom of the machine tool, thereby it is necessary to remove them by rather difficult and long removal operations.

A further drawback of the above prior section member cutting and drilling machine is that some section members, for example of a triangular shape, cannot be safely locked, since the locking and feeding device therefore must include two flat and mutual parallel surfaces designed for firmly locking said work pieces.

### SUMMARY OF THE INVENTION

Accordingly, the main object of present the invention is to overcome the above mentioned drawbacks of the prior art, by providing a novel device, to be fitted to a section member sawing or drilling machine tool for properly feeding, locking and unloading metal section members.

According to one aspect of the present invention, the above object is achieved by a metal section member cutting or drilling machine tool, said machine tool having a bearing surface for bearing thereon a section member work piece to be machined, characterized in that said machine tool comprises a sliding guide parallel to a feeding, cutting and unloading surface of the machine tool, said sliding guide slidably supporting a contact plate in the form of a controllably energizable, respectively disenergizable magnet, and that said magnet plate is controllably driven by a controllable motor which, through a geared unit drives a pinion and rack assembly parallel to said sliding guide.

Further advantages of the invention will become more apparent hereinafter from the following disclosure, dependent claims and accompanying drawings.

### BRIEF DESCRIPTION OF THE DRAWINGS

The present invention will become more apparent hereinafter from a detailed disclosure of a preferred embodiment thereof, given by way of an indicative example only and shown in the accompanying drawings, where:

FIG. 1 is a perspective view showing a sawing machine for cutting large size metal section members, including a section member feeding, locating and unloading device, also according to the present invention;

FIG. 2 is a front view of the sawing machine;

FIG. 3 is a further front view showing the section member feeding, locating and unloading device according to the present invention.

### DESCRIPTION OF THE PREFERRED EMBODIMENT

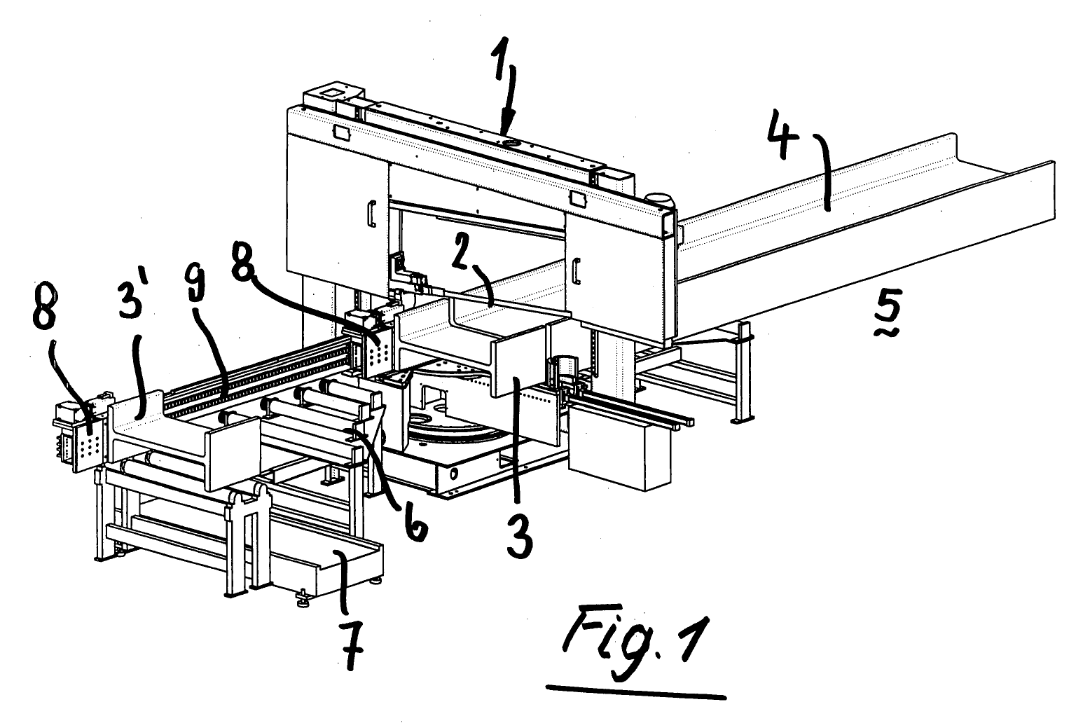

With reference to FIG. 1, a metal section member sawing machine 1 advantageously comprises a cutting strip blade 2 having a horizontal portion, for cutting metal section member work pieces 3 having any desired length and angular arrangement, from longer section members, generally indicated by 4, and which are conventionally supported and fed by a horizontal roller track 5, not specifically shown in FIG. 1. Each cut work piece 3 is fed to a further roller track 6, at the end of which the work piece 3′ is delivered to yet another underlying cross unloading track 7.

In this connection it should be pointed out that it would be also advantageously possible to unload small pieces or metal off-cuts, generated, for example, in butt-cutting said section members 4.

In particular, at the cutting region, of said cutting strip blade 2, is arranged a driving device 8 for driving the section members 4, respectively the cut work pieces 3, said device 8 being in turn precisely driven along two parallel guides generally indicated by 9.

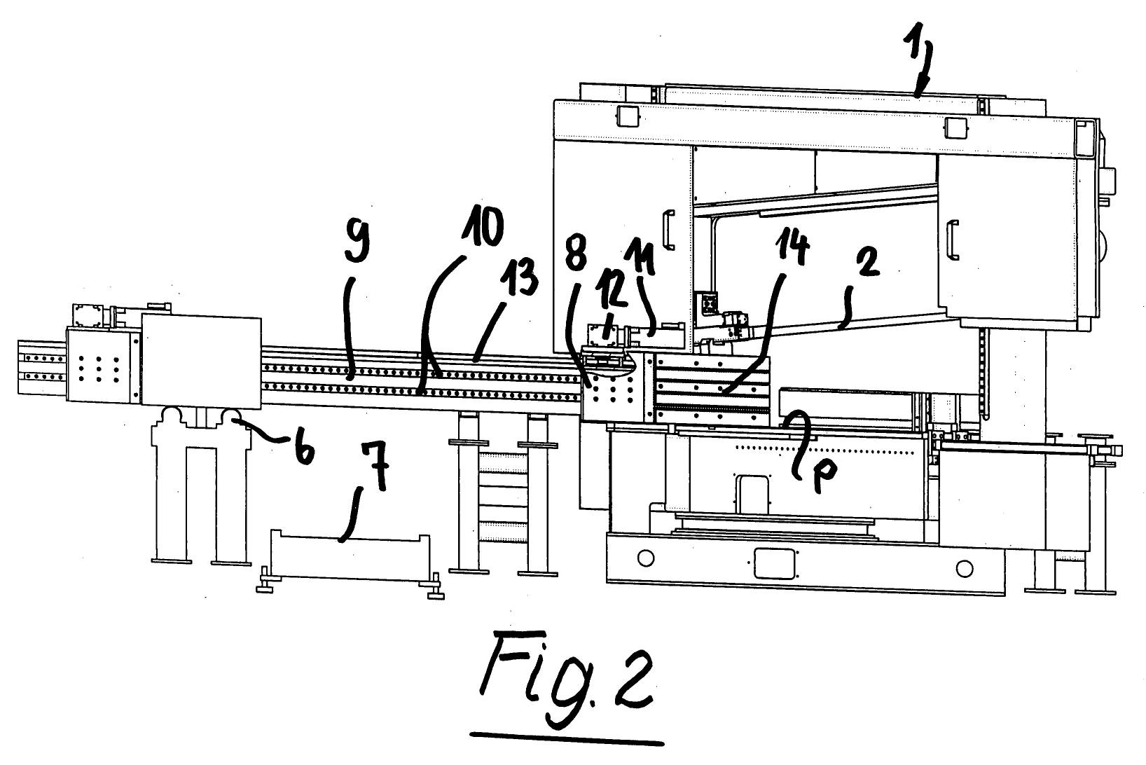

FIG. 2 is a front view showing the sawing machine 1 and the cutting strip blade 2 and said parallel guides 9 with their guide tracks 10, designed as precision guides extending from the cutting region, thereat the cutting blade 2 operates, to the end of the track 6, extending though said cross unloading track 7. The device 8, operating as a driving carriage for the section members 4, 3, 3′ is driven along said guide tracks 10 by a driving motor 11, controlled by the machine tool 1 numerical control device.

In particular, the motor 11 drives a geared unit 12, having a gear wheel (not shown) engaging with a rack 13 parallel to the guide tracks 10.

Said device 8 is moreover coupled to a bearing plate 14 which can be controllably either energized (through the NC system of the machine tool) to operate as a magnet, disenergized, thereby loosing its magnet function.

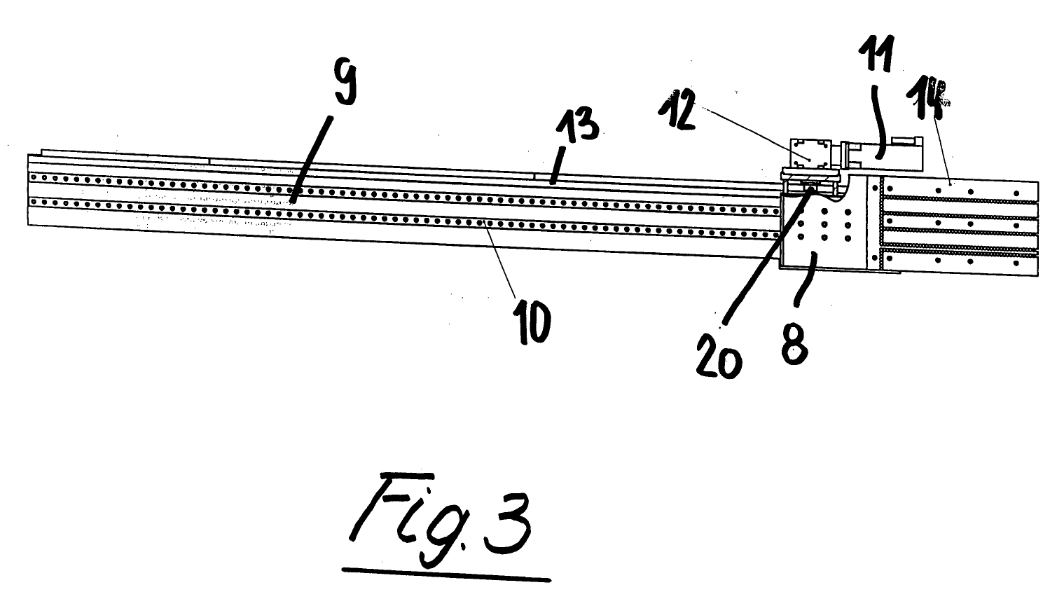

FIG. 3 is a detail view showing the parallel guide tracks 10 and 9 and the carriage 8 with its geared motor 12 which is controllably driven by said controllable motor 11 driving a gear wheel 20 engaging with said rack 13 parallel to said guide tracks 10.

The inventive device operates as follows:

During the metal section member cutting operation, the device 8 operates as a carriage to be arranged, together with the magnet plate 14, near the cutting blade 2, as is shown in FIG. 1.

In this condition, the device 8 and magnetic plate 14 will firmly restrain the work piece 4 which, after the cutting operation to provide the cut section member 3 is driven to the position 3′ (FIG. 1), while, by disenergizing the magnet plate 14, said work piece 3 will be unloaded.

Since said work pieces 3 have a small size, they can also be unloaded as off-cuts (generated upon starting the cutting step, for example) on the cross belt track 7.

Thus, said NC controlled motor 11 driving through said geared unit 12 the pinion 20 engaging with the rack 13 parallel to the precision guides of the device 8, allows to properly process the section members 4 and cut work pieces 3, 3′, so as to drive the latter through the driving surface P of the machine tool, depending on the cutting operations to be carried out and according to a work piece unloading control program.

Thus, the device 8 is so driven as to feed the section members 4 along the feeding surface or plane P, to a butt-cutting position, or said section members 4 can also be fed to a cutting position to be cut to any desired length by the cutting blade 2 of the tool machine 1 (or drilled by not shown drilling assemblies).

The thus cut work pieces 3 can in turn be fed along the feeding plane or surface P, by said device 8, to be controllably driven, under the control of the NC unit of the machine tool, along the parallel guides 9, to a position above the cross unloading belt track 7.

The work pieces 3 can also be brought to a position 3′ at the end of the horizontal roller track 6.

Thus, the invention provides a very operatively reliable and simple construction device, allowing a section members 4 to be cut to be precisely driven. Moreover, the cut work pieces 3 can be unloaded by said unloading device 8 and brought to a well defined end position (by energizing/disenergizing the magnetic plate 14).

Finally, since the inventive device is advantageously arranged at the rear or back region of the sawing machine 1, the front region of said sawing machine 1 is free of locking jaws or the like.

Furthermore, the above device also allows to safely cut and unload work pieces having a wedge, U, I, round or square cross-section shape.

While the device according to the present invention has been hereinabove disclosed as designed for fitting to a horizontal belt sawing machine, it should be apparent that the section member piece locating, feeding and unloading device can also be used in other machine tools, for example in a steel section member drilling machine tool.

1. A section member work piece (4) cutting or drilling machine tool (1), said machine tool including a supporting surface (P) for supporting, feeding, cutting and unloading a section member work piece (4) thereon, characterized in that said machine tool further comprises a sliding guide track (9, 10) parallel to said supporting surface (P), said sliding guide slidably supporting a contact plate device (8, 14) in the form of a controllably energizable, respectively disenergizable magnet, and that said magnet (14) plate (8) is controllably driven by a controllable driving motor (11) which, through a geared unit (12), drives a pinion (20) and rack assembly (13) parallel to said sliding guide track (9, 10).

2. A section member cutting or drilling machine tool, according to claim 1, characterized in that said machine tool further comprises a roller track (6) and, at an end of said roller track (6), an underlying cross unloading track (7).

3. A section member cutting or drilling machine tool, according to claim 1, characterized in that said plate device (8) for driving said section member work piece (4), respectively a cut section member work piece (3), is slidably supported, in a precisely controlled manner, along two parallel guides.

4. A section member cutting or drilling machine tool, according to claim 1, characterized in that said parallel guide tracks (9) comprise guide rails (10) formed as precision guides extending from a cutting region where a cutting blades (2) operates to an end of said roller track (6), while passing through said underlying cross unloading track (7).

5. A section member cutting or drilling machine tool, according to claim 1, characterized in that said plate device (8) is operatively coupled to a bearing plate (14) controllably energizable and disenergizable supporting plate (14) controlled by a numerical control device of said machine tool.

6. A section member cutting or drilling machine tool, according to claim 1, characterized in that said parallel guide tracks (9) are arranged at a rear or back region of said sawing machine (1).
